(19) United States
(12) Patent Application Publication
(10) Pub. No.: US 2024/0003782 A1
(43) Pub. Date: Jan. 4, 2024

(54) METHOD FOR MONITORING THE OPERATION OF A PUMP STATION

(71) Applicant: Xylem Europe GmbH, Schaffhausen (CH)

(72) Inventors: Martin Wessman, Solna (SE); Nils Irestedt, Stockholm (SE); Alexander Fullemann, Stockholm (SE)

(73) Assignee: Xylem Europe GmbH, Schaffhausen (CH)

(21) Appl. No.: 18/038,391

(22) PCT Filed: Nov. 24, 2021
(86) PCT No.: PCT/EP2021/082751

§ 371 Date: May 23, 2023

(30) Foreign Application Priority Data
Nov. 24, 2020 (EP) 20209485.0

(51) Int. Cl. G01M 99/00; E03F 5/22

(52) U.S. Cl. CPC G01M 99/005; E03F 5/22

(57) ABSTRACT

A method for monitoring the operation of a pump station comprising a tank for temporary storage of a liquid, an inlet for influent liquid, an outlet, and at least one pump configured for transporting the liquid away from the tank via the outlet. The method comprises steps. Monitoring an inflow of liquid to the tank during at least a part of a predetermined time period (T) and determining Inflow data (IN) representative of the inflow during T. Determining Pump Station Max Capacity data (PSMC) that is representative of the max capacity of pumped liquid from the tank during T. For T, determining a momentary Pump Station Capacity Utilization (PSCU_{M}) based on IN and PSMC, using the overall formula PSCU_{M} (%)=100*IN/PSMC. Determining a typical Pump Station Capacity Utilization (PSCU_{T}) for the pump station based on at least one momentary PSCU_{M} value.

### TECHNICAL FIELD OF THE INVENTION

The present invention belongs to the technical field of pump stations and methods for monitoring the operation of such pump stations, especially pump stations configured for pumping liquid comprising solid matter, such as wastewater. The pump station comprises a tank for temporary storage of a liquid, an inlet for influent liquid, an outlet and at least one pump configured for transporting the liquid away from the tank via said outlet. The pump station is in operation when the tank is capable/configured to receive liquid, both when the pump is active and inactive.

### BACKGROUND OF THE INVENTION

A pump station typically has a reservoir for holding a liquid, such as a well, a sump, a holding tank or a tank. In some pump stations, there may be multiple wells/sumps that are separated from or connected to each other. One or more pumps can be used to transport liquid into or out of the reservoir. For example, pumps may be used to transport sewage out of sumps in sewage pump stations, or to pump fresh water into holding tanks in clean water boost stations.

A typical liquid reservoir for wastewater has an inlet to admit liquid to enter the tank and an outlet through which the liquid is removed/discharged from the tank. Each liquid reservoir has one or more pumps associated with the outlet. The pumps, when activated and in operation, transport the liquid, as required based on appropriate control signals. A single operator may have responsibility for many pump stations scattered over vast geographic areas, for instance the operator may have responsibility for hundreds or thousands of individual pumps. It is known to maintain and service pumps and pump stations at regular time intervals. However, this may result in pumps that are operating within acceptable parameters being serviced when not needed, and faulty pumps not being maintained when needed, thus resulting in failure. It is also known to monitor pump operating parameters, such as the individual pump efficiency (the electrical energy required to move a fixed volume of liquid), to determine whether a pump station is operating within acceptable parameters, and normal pump station service is based on the monitored parameters. However, the pump stations operate under different conditions, i.e. different operational environments, in relation to each other and also over time.

The population of urban areas, and the presence of industries and companies, change all the time and thereby the generation of wastewater change over time in each specific area. Each wastewater transportation system, upon installation, is designed to handle a theoretical amount of wastewater. However, after installation and over time there is no good way to determine the capacity utilization or capacity shortage risk of the system and of different pump stations, there is also no optimal automatic way to decide/prioritise what part of the system and/or pump stations, that need to be upgraded or need service/maintenance.

There are known prior art, such as U.S. Pat. No. 55,979,960 and EP 3567173, that disclose systems that provide alarm when flooding of a pump station is taking place or is imminent. However, such alarms are reactive and not proactive.

### OBJECT OF THE INVENTION

The present invention aims at obviating the aforementioned disadvantages and failings of previously known pump station monitoring and control systems.

A primary object of the present invention is to provide an improved method for monitoring pump stations, whereby an operator may more accurately compare performance and capacity utilization of different pump stations working under different environmental conditions and over time in order to be able to prioritize service and maintenance of said pump stations.

It is an object of the present invention to provide an improved method for monitoring pump stations, whereby an operator may understand the pump station performance in relation to real life conditions and may determine available capacity margins of the pump stations.

It is an object of the present invention to provide an improved method for monitoring pump stations, whereby the method is proactive and provides tools for the operator to decide about investments.

### SUMMARY OF THE INVENTION

According to the invention at least the primary object is attained by means of the initially defined method for monitoring the operation of a pump station, having the features defined in the independent claim. Preferred embodiments of the present invention are further defined in the dependent claims.

According to the present invention, there is provided a method for monitoring the operation of a pump station, wherein the pump station comprises a tank for temporary storage of a liquid, an inlet for influent liquid, an outlet and at least one pump configured for transporting the liquid away from the tank via said outlet, the method is characterized by the steps of:
monitoring the inflow of liquid to the tank during at least a part of a predetermined time period (T) and determining Inflow data (IN) [volume per time unit] that is representative for the inflow of liquid to the tank of the pump station during the predetermined time period (T),
determining Pump Station Max Capacity data (PSMC) [volume per time unit] that is representative for the max capacity of pumped liquid from the tank of the pump station during the predetermined time period (T),
for the predetermined time period, determining a momentary Pump Station Capacity Utilization (PSCU_{M}) based on the determined values of Inflow data (IN) and Pump Station Max Capacity data (PSMC), using the overall formula PSCU_{M} (%)=100*IN/PSMC, and
determining a typical Pump Station Capacity Utilization (PSCU_{T}) for the pump station, that is representative for the capacity utilization of the pump station over time, based on at least one momentary Pump Station Capacity Utilization (PSCU_{M}) value.

Thus, the present invention is based on the insight of determining a typical Pump Station Capacity Utilization (PSCU_{T}) for the pump station based on one or more historical values and thereby the operator may monitor/analyze the trend/development of the typical Pump Station Capacity Utilization (PSCU_{T}). An increasing trend, and the rate of the increase, provides valuable input for the operator and/or may automatically provide trend alarm, and thereby future flooding may be prevented. The operator may also determine/analyze the risk of flooding of the pump station based on one value, or a few values, of typical Pump Station Capacity Utilization (PSCU_{T}). Thus, the operator assesses the capacity utilization, i.e. capacity margin, of the pump station and thereby the risk of flooding for different pump stations.

In particular, the determination of service/maintenance need is highly improved with the inventive method as values of typical Pump Station Capacity Utilization (PSCU_{T}) can be compared over time, i.e. before and after a change or service of the pump and/or parts of the pump station which is not possible with known methods. Thereto, by means of the inventive method different pump stations may be compared with each other. Thus, the operator is given a method that will help the operator to prioritize maintenance and investments in a pump station network.

Using the method according to the present invention one can determine if the dimension/design of an outlet piping from the pump station is optimal or not and/or if said outlet piping is getting clogged. In the method according to the present invention one can compare old measurement data with new measurement data regardless of the pump station is changed and/or the pump is renewed.

In various example embodiments of the present invention the step of determining the Inflow data (IN) comprises the sub-steps of:
determining a rest-time (REST) required for the liquid level in the tank to rise from a pump stop liquid level (STOP) to a pump start liquid level (START) when no pump is active, wherein the rest-time (REST) is part of the predetermined time period (T),
determining the Inflow data (IN) that is representative for the inflow of liquid during the predetermined time period (T) by dividing a volume (V) by the determined rest-time (REST), [V/REST], wherein the volume (V) is the liquid volume in the tank between said pump start liquid level (START) and said pump stop liquid level (STOP).

In various example embodiments of the present invention the step of determining the Pump Station Max Capacity data (PSMC) comprises the sub-steps of:
determining a run-time (RUN) required for the liquid level in the tank to lower from a pump start liquid level (START) to a pump stop liquid level (STOP) when all pumps in the pump station are active concurrently and operated at maximum operational speed, wherein the run-time (RUN) is part of the predetermined time period (T), and
determining the Pump Station Max Capacity data (PSMC) that is representative for the max capacity of the pump station during the predetermined time period (T) by dividing a volume (V) by the determined run-time (RUN) and adding the Inflow data (IN) representative for the inflow of liquid during the predetermined time period (T), [(V/RUN)+IN], wherein the volume (V) is the liquid volume in the tank between said pump start liquid level (START) and said pump stop liquid level (STOP).

It is advantageous to use said preferred embodiments whereby the determination of the momentary Pump Station Capacity Utilization is only dependent on rest-time (REST) and run-time (RUN) that is already available in most pump station monitoring units.

However, the inventive method is not limited to all pumps operating concurrently and at maximum operational speed, but is equally useful when not all pumps are active concurrently and/or is operating at reduced operational speed.

In various example embodiments of the present invention the pump station comprises a plurality of pumps constituted by a first subset of pumps (P1) and a second subset of pumps (P2), wherein the first subset of pumps (P1) and the second subset of pumps (P2) are not active concurrently during the predetermined time period (T), and wherein the step of determining the Pump Station Max Capacity data (PSMC) comprises the sub-steps of:
determining a First Subset Max Capacity data (P1_MC) during a first pump cycle during the predetermined time period (T), wherein the First Subset Max Capacity data (P1_MC) is representative for the max capacity of the first subset of pumps (P1) during the predetermined time period (T),
determining a Second Subset Max Capacity data (P2_MC) during a second pump cycle during the predetermined time period (T), wherein the Second Subset Max Capacity data (P2_MC) is representative for the max capacity of the second subset of pumps (P2) during the predetermined time period (T), and
determining the Pump Station Max Capacity data (PSMC) that is representative for the max capacity of the pump station during the predetermined time period (T) by multiplying a reduction factor (X) with the sum of the First Subset Max Capacity data (P1_MC) and the Second Subset Max Capacity data (P2_MC), [X*(P1_MC+P2_MC)], wherein the reduction factor is in the range 0,5-0,9.

It is an important understanding of the inventors that the maximum capacity of all pumps of the pump station is not the sum of the max capacity of each subset of pumps.

In various example embodiments of the present invention the pumps of the first subset of pumps (P1) are active concurrently and operated at a reduced operational speed that is less than the maximum operational speed, and wherein the reduced operational speed corresponds to a reduced first Outflow (P1_Q_{R}) and an actual first run-time (P1_RUN_{A}) required for the liquid level in the tank to lower from a pump start liquid level (START) to a pump stop liquid level (STOP), wherein the determination of the first run-time (P1_RUN) comprises multiplying the actual first run-time (P1_RUN_{A}) with the ratio between the reduced first Outflow (P1_Q_{R}) and a maximum first Outflow (P1_Q_{M}), wherein the ratio between the reduced first Outflow (P1_Q_{R}) and the maximum first Outflow (P1_Q_{M}) is determined based on a predetermined relationship between operational speed and first Outflow (P1_Q), and the reduced operational speed.

In various example embodiments of the present invention the typical Pump Station Capacity Utilization (PSCU_{T}) is compared with predetermined thresholds A and B, wherein A is in the range 85-100% and B is equal to the ratio between the lowest of the First Subset Max Capacity data (P1_MC) and the Second Subset Max Capacity data (P2_MC) divided by the Pump Station Max Capacity data (PSMC), [100*min(P1_MC;P2_MC)/PSMC], in order to estimate the capacity status of the pump station. Thereby an automatic alarm may be triggered in order to assist the operator, i.e. there is a risk that the pump station will become flooded if a peak inflow occur or if one pump malfunction, respectively.

In yet another aspect of the present invention it is provided a computer-readable storage medium having computer-readable program code portions embedded therein, wherein the computer-readable program code portions when executed by a computer cause the computer to carry out the steps of the method according to claim 1 in order to determine a typical Pump Station Capacity Utilization (PSCU_{T}).

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawing, wherein:

FIG. 1 is a schematic view of an example embodiment of a pump station according to the present invention.

### DETAILED DESCRIPTION OF PREFERRED EMBODIMENTS OF THE INVENTION

The invention is applicable to a pump station and concern monitoring of a pump station.

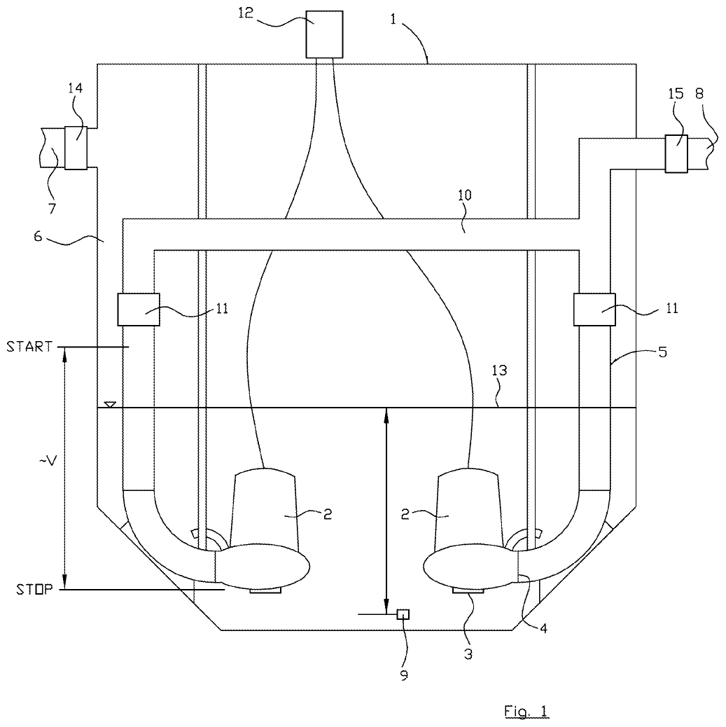

Reference is initially made to FIG. 1 illustrating a pump station 1, e.g. a wastewater pump station, however other liquids may be pumped and the invention is not limited to wastewater.

The pump station 1 comprises at least one pump 2 having an inlet 3 and an outlet 4, an outlet pipe 5 connected to the pump 2 and extending from the pump outlet 4. The pump station 1 comprises a tank 6, also known as reservoir, sump, etc. configured for temporary storage of liquid. The pump station 1 comprises an inlet 7 for incoming/influent liquid and an outlet 8 for discharged/effluent liquid. The pump 2 is configured for transporting the liquid away from the tank 6 via the outlet pipe 5 and said outlet 8. The pump 2 is preferably located in the tank 6, and the pump 2 may be located in partly or fully submerged position or in a dry position, or located in a dry position outside the tank 6.

The disclosed pump station 1 also comprises a level sensor 9 located in the tank 6 and preferably in a position always submerged when the pump station 1 is in operation. Thus, the level sensor 9 is preferably located below the inlet 3 of the pump 2. According to various alternative embodiments the level sensor is constituted by a dry installed level sensor, e.g. using ultrasound, radar, etc., hanging above the liquid level and/or located outside the tank 6. According to various embodiments the pump station 1 comprises a plurality of level sensors, such as level switches located at different levels in the tank, e.g. start level and stop level, which will be tilted by the liquid surface. The purpose of the level sensor 9, or level sensors, is to start and stop the pump 2 when the liquid surface is located at predetermined levels within the tank 6.

Usually the pump stations 1 comprises at least two pumps, wherein the second pump is used to prevent flooding and/or as a backup if the first pump malfunctions and/or the plurality of pumps alternate. The second pump having an inlet and an outlet, an outlet pipe 10 extending from the pump outlet and is connected to the outlet pipe 5 of the first pump 2. The pump station 1 may comprise one or more non-return valves 11 arranged to prevent the pumped flow from one of the pumps to return to the tank 6 via the other pump, and also to prevent the liquid in the outgoing piping from returning to the tank 6 when the pumps are deactivated. The plurality of pumps 2 may be of the same or different size, i.e. rated power and capacity.

A local control unit 12 is operatively connected to the pumps 2 and to different sensors in the pump station 1, and may further be operatively connected to a remote/external control unit (not shown). The local control unit may by partly or fully located inside the pump 2. External outlet piping is connected to the outlet 8 of the tank 6 and the external outlet piping guides the pumped liquid for example to another pump station and/or a wastewater plant. Everything described in connection with said at least one pump 2 is applicable also for the other pumps in the pump station 1. During operation of the pump station 1 the liquid level 13 in the tank 6 will rise and fall depending on the influent liquid and the operation of the pumps 2.

The inventive method comprises the steps of:
monitoring the inflow of liquid to the tank 6 during at least a part of a predetermined time period (T) and determining Inflow data (IN) [volume per time unit] that is representative for the inflow of liquid to the tank 6 of the pump station 1 during the predetermined time period (T),
determining Pump Station Max Capacity data (PSMC) [volume per time unit] that is representative for the max capacity of pumped liquid from the tank 6 of the pump station 1 during the predetermined time period (T),
for the predetermined time period, determining a momentary Pump Station Capacity Utilization (PSCU_{M}) based on the determined values of Inflow data (IN) and Pump Station Max Capacity data (PSMC), using the overall formula PSCU_{M} (%)=100*IN/PSMC, and
determining a typical Pump Station Capacity Utilization (PSCU_{T}) for the pump station 1, that is representative for the capacity utilization of the pump station 1 over time, based on at least one momentary Pump Station Capacity Utilization (PSCU_{M}) value.

Said predetermined time period (T) is preferably one or more pump cycles, wherein each pump cycle extends from one deactivation of the pump 2 to the next deactivation of the pump 2 an includes one period wherein the pump 2 is inactive and the liquid level 13 in the tank 6 increases (goes up) and one period wherein the pump is active and the liquid level 13 in the tank 6 decreases (goes down). According to the embodiments wherein the predetermined time period (T) comprises a plurality of pump cycles, said pump cycles are preferably consecutive pump cycles. According to various alternatives the predetermined time period (T) is constituted by one or more hours, or one or more days (i.e. 24 hours), or one or more weeks. It is known that the inflow to a pump station 1 alters during the day, during the week and also during the year. It is preferred that the predetermined time period (T) is equal to or less than one hour.

Capacity is the amount of liquid that can be transported from or through the pump station 1. The capacity is dependent on the max capacity of the different pumps, outlet piping diameters, and wear and condition of pumps and piping. Capacity utilization is the incoming flow of liquid compared to the pump station 1 capacity.

Said Inflow data (IN), i.e. the inflow to the pump station 1, and said Pump Station Max Capacity data (PSMC), i.e. the maximum effluent from the pump station 1, are quantified in volume per time unit, such as liters per second. The Inflow data (IN) can be constituted by the actual/true inflow during the entire predetermined time period (T), the actual/true inflow during a part of said time period (T), an average value over the time period (T) based on a plurality of measurements, etc., i.e. the Inflow data (IN) shall provide a good representation of the inflow volume/characteristics during the predetermined time period (T). The Pump Station Max Capacity data (PSMC) can be constituted by the actual/true volume of the pumped liquid during the entire predetermined time period (T), the actual/true pumped volume during a part of said time period (T), an average value over the time period (T) based on a plurality of measurements, etc., i.e. the Pump Station Max Capacity data (PSMC) shall provide a good representation of the pumped volume/characteristics during the predetermined time period (T).

The Pump Station Max Capacity data (PSMC) is the maximum Outflow (Q_{M}) corresponding to all pumps 2 in the pump station 1 being active concurrently and operated at maximum operational speed, e.g. rated operational speed. The maximum Outflow (Q_{M}) will change over time due to wear of the pumps 2, clogging of the outlet piping, size of the pumps 2, size of the outlet piping, number of pumps 2 in the pump station 1, etc. Thus, the Pump Station Max Capacity data (PSMC) shall provide a good representation of the maximum output volume from the pump station 1, i.e. from the pumps 2 of the pump station 1. It shall be pointed out that in some pump stations and/or during certain situations, not all installed pumps 2 in a pump station 1 are allowed to be active concurrently and/or be operated at rated operational speed, due to physical or design constraints of the specific pump station and/or outlet piping. Thus, herein, the term “all pumps 2 of the pump station 1 being active concurrently and operated at maximum operational speed” shall be understood to mean “the combination of pumps 2 in the pump station 1 that are allowed to be active concurrently and operated at maximum allowable operational speed and that provides the maximum outflow (Q_{M}) from the pump station 1”. Thus, the maximum allowable speed providing the maximum outflow (Q_{M}) from the pump station may not necessarily be the rated operational speed.

The typical Pump Station Capacity Utilization (PSCU_{T}) for the pump station 1 is based on at least one momentary Pump Station Capacity Utilization (PSCU_{M}) value, preferably a plurality of momentary values. The typical Pump Station Capacity Utilization (PSCU_{T}) shall provide a good representation about the capacity utilization of the pump station 1 over time. The typical Pump Station Capacity Utilization (PSCU_{T}) can be constituted by the maximum momentary Pump Station Capacity Utilization (PSCU_{M}) value per day, per week, per month, etc., or an average of a plurality of momentary Pump Station Capacity Utilization (PSCU_{M}) values per day, per week, per month, etc., or an average of historic peak values the last month, quarter year, half year, etc.

The typical Pump Station Capacity Utilization (PSCU_{T}) value for the pump station 1, and the trend of the typical value, provides a base for the operator to make decisions about service, maintenance, renewal, up-sizing, etc.

According to various embodiments the step of determining the Inflow data (IN) comprises the sub-steps of:
determining a rest-time (REST) required for the liquid level in the tank 6 to rise from a pump stop liquid level (STOP) to a pump start liquid level (START) when no pump 2 is active, wherein the rest-time (REST) is part of the predetermined time period (T),
determining the Inflow data (IN) that is representative for the inflow of liquid during the predetermined time period (T) by dividing a volume (V) by the determined rest-time (REST), [V/REST], wherein the volume (V) is the liquid volume in the tank 6 between said pump start liquid level (START) and said pump stop liquid level (STOP).

When no pump 2 is active is defined as no liquid is discharged from the pump station. Thus, a slowly rotating impeller in the pump will not generate any outflow and the pump 2 is defined as inactive. The volume (V) and the rest-time (REST) can alternatively be determined using other known/preset liquid levels in the tank 6. Thus, the volume (V) and the rest-time (REST) can be determined in many different ways instead of using the pump start liquid level (START) and the pump stop liquid level (STOP), i.e. may be determined using a subset of the volume between the pump stop liquid level and the pump start liquid level. Thus, on a more general level, herein the volume (V) shall be regarded as a predetermined volume in the tank 6, which volume is delimited by an upper liquid level (UP) and a lower liquid level (LOW), and the rest-time (REST) shall be determined using the lower liquid level (LOW) and the upper liquid level (UP), wherein pump start liquid level (START) and pump stop liquid level (STOP) are specific values of the general terms upper liquid level (UP) and lower liquid level (LOW), respectively.

Thus, according to various embodiments the step of determining the Inflow data (IN) comprises the sub-steps of:
determining a rest-time (REST) required for the liquid level in the tank 6 to rise from a lower liquid level (LOW) to an upper liquid level (UP) when no pump 2 is active, wherein the rest-time (REST) is part of the predetermined time period (T),
determining the Inflow data (IN) that is representative for the inflow of liquid during the predetermined time period (T) by dividing a volume (V) by the determined rest-time (REST), [V/REST], wherein the volume (V) is the liquid volume in the tank 6 between said upper liquid level (UP) and said lower liquid level (LOW).

According to alternative embodiments the Inflow data (IN) is determined using an inlet flowmeter 14, in order to determine the actual inflow during a part of or during the entire predetermined time period (T).

When all pumps 2 are active concurrently and are operated at maximum operational speed, the step of determining the Pump Station Max Capacity data (PSMC) comprises the sub-steps of:
determining a run-time (RUN) required for the liquid level in the tank 6 to lower from the pump start liquid level (START) to the pump stop liquid level (STOP), wherein the run-time (RUN) is part of the predetermined time period (T), and
determining the Pump Station Max Capacity data (PSMC) that is representative for the max capacity of the pump station 1 during the predetermined time period (T) by dividing a volume (V) by the determined run-time (RUN) and adding the Inflow data (IN) representative for the inflow of liquid during the predetermined time period (T), [(V/RUN)+IN].

The run-time (RUN) can alternatively be determined using other known/set liquid levels in the tank 6. In line with the above, the run-time (RUN) can be determined in many different ways instead of using the pump start liquid level (START) and the pump stop liquid level (STOP), i.e. may be determined using a subset of the volume between the pump stop liquid level and the pump start liquid level. Thus, on a more general level, herein the run-time (RUN) shall be determined using said upper liquid level (UP) and said lower liquid level (LOW).

Thus, according to alternative embodiments, when all pumps 2 are active concurrently and are operated at maximum operational speed, the step of determining the Pump Station Max Capacity data (PSMC) comprises the sub-steps of:
determining a run-time (RUN) required for the liquid level in the tank 6 to lower from the upper liquid level (UP) to the lower liquid level (LOW), wherein the run-time (RUN) is part of the predetermined time period (T), and
determining the Pump Station Max Capacity data (PSMC) that is representative for the max capacity of the pump station 1 during the predetermined time period (T) by dividing a volume (V) by the determined run-time (RUN) and adding the Inflow data (IN) representative for the inflow of liquid during the predetermined time period (T), [(V/RUN)+IN], wherein the volume (V) is the liquid volume in the tank 6 between said upper liquid level (UP) and said lower liquid level (LOW).

Thus, according to the preferred embodiment a single pump cycle is constituted by one rest-time (REST) and one run-time (RUN).

According to alternative embodiments the Pump Station Max Capacity data (PSMC) is determined using an outlet flowmeter 15, in order to determine the actual outflow during a part of or during the entire predetermined time period (T).

When using the preferred embodiments to determine the Inflow data (IN) and the Pump Station Max Capacity data (PSMC) the volume (V) parameter is both in the numerator and in the denominator and can be omitted/excluded.

All pumps 2 are active concurrently and are operated at maximum/rated operational speed is for instance during a so-called outlet pipe cleaning sequence, that can be scheduled in the control unit 12, manually initiated by an operator, automatically initiated by the control unit 12 based on need, or during high inflow wherein one pump 2 is not sufficient. In a well-functioning and properly dimensioned pump station 1 there is almost never need for all pumps 2 to be active concurrently and be operated at maximum/rated operational speed in order to handle the incoming liquid.

According to various embodiments the pump station 1 comprises a plurality of pumps 2, and these pumps are constituted by a first subset of pumps (P1) and a second subset of pumps (P2). In most pump stations 1 the first subset of pumps (P1) and the second subset of pumps (P2), respectively, is constituted by a single pump 2, however, the first subset of pumps (P1) and/or the second subset of pumps (P2) may comprises a plurality of pumps 2.

When all pumps 2 are not active concurrently and the active pumps 2 are operated at maximum operational speed, the step of determining the Pump Station Max Capacity data (PSMC) comprises the sub-steps of:
determining a First Subset Max Capacity data (P1_MC) during a first pump cycle during the predetermined time period (T), wherein the First Subset Max Capacity data (P1_MC) is representative for the max capacity of the first subset of pumps (P1) during the predetermined time period (T),
determining a Second Subset Max Capacity data (P2_MC) during a second pump cycle during the predetermined time period (T), wherein the Second Subset Max Capacity data (P2_MC) is representative for the max capacity of the second subset of pumps (P2) during the predetermined time period (T), and
determining the Pump Station Max Capacity data (PSMC) that is representative for the max capacity of the pump station 1 during the predetermined time period (T) by multiplying a reduction factor (X) with the sum of the First Subset Max Capacity data (P1_MC) and the Second Subset Max Capacity data (P2_MC), [X*(P1_MC+P2_MC)], wherein the reduction factor is in the range 0,6-0,9.

It shall be pointed out that any of the said first pump cycle and said second pump cycle can occur first in time, and the pump cycles can take place directly after each other or be separated in time.

The reduction factor (X) is used since the maximum Outflow (Q_{M}) when all pumps 2 are active and operated at maximum operation speed is not equal to the sum of the individual outflow of each pump 2. This phenomenon comes from increasing flow resistance in the outlet piping in relation to increasing flow velocity.

As default the reduction factor (X) is preferably set to 0,7. However, the reduction factor (X) is preferably updated at regular intervals based on known values of Pump Station Max Capacity data (PSMC), the First Subset Max Capacity data (P1_MC) and the Second Subset Max Capacity data (P2_MC). Preferably the last known values of set parameters are used. These values/parameters are determined as stated above and below. The reduction factor (X) is updated/determined by dividing the Pump Station Max Capacity data (PSMC) with the sum of the First Subset Max Capacity data (P1_MC) and the Second Subset Max Capacity data (P2_MC), [PSMC/(P1_MC+P2_MC)].

According to various embodiments, the step of determining the First Subset Max Capacity data (P1_MC) comprises the sub-steps of:
determining a first run-time (P1_RUN) required for the liquid level 13 in the tank 6 to lower from a pump start liquid level (START) to a pump stop liquid level (STOP) when the pumps of the first subset of pumps (P1) are active concurrently and operated at maximum operational speed, wherein the first run-time (P1_RUN) is part of the predetermined time period (T), and
determining the First Subset Max Capacity data (P1_MC) by dividing a volume (V) by the determined first run-time (P1_RUN) and adding a first Inflow data (P1_IN) that is representative for the inflow of liquid during the first pump cycle, [(V/P1_RUN)+P1_IN].

According to various embodiments, the first Inflow data (P1_IN) is determined using the sub-steps of:
determining a first rest-time (P1_REST) required for the liquid level 13 in the tank 6 to rise from a pump stop liquid level (STOP) to a pump start liquid level (START) when no pump 2 is active, wherein the first rest-time (P1_REST) is part of the predetermined time period (T), and
determining the first Inflow data (P1_IN) that is representative for the inflow of liquid during the predetermined time period (T) by dividing a volume (V) by the determined first rest-time (P1_REST), [V/P1_REST].

According to various embodiments, the step of determining the Second Subset Max Capacity data (P2_MC) comprises the sub-steps of:
determining a second run-time (P2_RUN) required for the liquid level 13 in the tank 6 to lower from a pump start liquid level (START) to a pump stop liquid level (STOP) when the pumps of the second subset of pumps (P2) are active concurrently and operated at maximum operational speed, wherein the second run-time (P2_RUN) is part of the predetermined time period (T), and
determining the Second Subset Max Capacity data (P2_MC) by dividing a volume (V) by the determined second run-time (P2_RUN) and adding a second Inflow data (P2_IN) that is representative for the inflow of liquid during the second pump cycle, [(V/P2_RUN)+P2_IN].

According to various embodiments, the second Inflow data (P2_IN) is determined using the sub-steps of:
determining a second rest-time (P2_REST) required for the liquid level in the tank 6 to rise from a pump stop liquid level (STOP) to a pump start liquid level (START) when no pump 2 is active, wherein the second rest-time (P2_REST) is part of the predetermined time period (T), and
determining the second Inflow data (P2_IN) that is representative for the inflow of liquid during the predetermined time period (T) by dividing a volume (V) by the determined second rest-time (P2_REST), [V/P2_REST].

According to an alternative embodiment the first rest-time (P1_REST) and the second rest-time (P2_REST) can be the same value and be determined simultaneously. It shall be pointed out that when the pump station 1 comprises more than two different subsets of pumps, the above logic is copied/used for each possible subset of pumps.

When all pumps 2 are not active concurrently and the active pumps 2 are operated at a reduced operational speed that is less than the maximum operational speed, there must be a compensation in order to be able to determine the above run-times of the first subset of pumps (P1) and the second subset of pumps (P2). For each subset of pumps in the specific pump station 1, there is a known/predetermined relationship between the operational speed and outflow. The maximum operational speed provides a maximum outflow and a reduced operational speed provides a reduced outflow. The pumps 2 comprises internal and/or external Variable Frequency Drive (VFD) in order to be operated at reduced operational speed.

Thus, when the pumps of the first subset of pumps (P1) are active concurrently and operated at a reduced operational speed, said reduced operational speed corresponds to a reduced first Outflow (P1_Q_{R}) and an actual first run-time (P1_RUN_{A}) required for the liquid level in the tank 6 to lower from a pump start liquid level (START) to a pump stop liquid level (STOP). The determination of the first run-time (P1_RUN) comprises multiplying the actual first run-time (P1_RUN_{A}) with the ratio between the reduced first Outflow (P1_Q_{R}) and a maximum first Outflow (P1_Q_{M}), wherein the ratio between the reduced first Outflow (P1_Q_{R}) and the maximum first Outflow (P1_Q_{M}) is determined based on a predetermined relationship between operational speed and first Outflow (P1_Q), and the reduced operational speed.

Thus, when the pumps of the second subset of pumps (P2) are active concurrently and operated at a reduced operational speed, said reduced operational speed corresponds to a reduced second Outflow (P2_Q_{R}) and an actual second run-time (P2_RUN_{A}) required for the liquid level in the tank ( ) to lower from a pump start liquid level (START) to a pump stop liquid level (STOP). The determination of the second run-time (P2_RUN) comprises multiplying the actual second run-time (P2_RUN_{A}) with the ratio between the reduced second Outflow (P2_Q_{R}) and a maximum second Outflow (P2_Q_{M}), wherein the ratio between the reduced second Outflow (P2_Q_{R}) and the maximum second Outflow (P2_Q_{M}) is determined based on a predetermined relationship between operational speed and second Outflow (P2_Q), and the reduced operational speed.

In line with the above, please note that first run-time, second run-time, first rest-time, second rest-time, etc. alternatively may be determined using the general terms upper liquid level (UP) and lower liquid level (LOW) instead of the specific terms pump start liquid level (START) and the pump stop liquid level (STOP).

When the operator or the control unit 12 has access to the typical Pump Station Capacity Utilization (PSCU_{T}) value/values, said value/values can be compared with predetermined thresholds A and B, in order to estimate the capacity status of the pump station 1. Threshold A is preferably in the range 85-100% and threshold B is preferably equal to the ratio between the lowest of the First Subset Max Capacity data (P1_MC) and the Second Subset Max Capacity data (P2_MC) divided by the Pump Station Max Capacity data (PSMC), [100*min(P1_MC;P2_MC)/PSMC]. Threshold B is usually in the range 60-80%.

The typical Pump Station Capacity Utilization (PSCU_{T}) is determined based on the weekly peak values for the last 1-10 weeks, or the weekly average values for the last 1-10 weeks, or the 1-10 highest historic values.

When the typical Pump Station Capacity Utilization (PSCU_{T}) is below threshold B, there is no problem since each pump 2 is capable of pumping the typical inflow.

When the typical Pump Station Capacity Utilization (PSCU_{T}) is below threshold A but above threshold B, there might be a problem to discharge/pump the typical inflow if one of the pumps 2 malfunction.

When the typical Pump Station Capacity Utilization (PSCU_{T}) is above threshold A, there is an imminent problem to handle the typical inflow since not even all pumps are capable of pumping the typical inflow.

A computer-readable storage medium having computer-readable program code portions embedded therein, wherein the computer-readable program code portions when executed by a computer cause the computer to carry out the steps of the inventive method in order to determine a typical Pump Station Capacity Utilization (PSCU_{T}). The computer program product is preferably arranged in the control unit 12, in an external computer, in the cloud, in a service/diagnosis tool, a tablet/mobile phone, etc. that is connectable to the pump or pump station by wire or wireless.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1-15. (canceled)

16. A method for monitoring the operation of a pump station comprising a tank for temporary storage of a liquid, an inlet for influent liquid, an outlet, and at least one pump configured for transporting the liquid away from the tank via the outlet, the method comprising:
monitoring an inflow of the influent liquid to the tank during at least a part of a predetermined time period (T) and determining an Inflow data (IN) value in volume per unit time representative of the inflow of the influent liquid to the tank of the pump station during the predetermined time period (T);
determining a Pump Station Max Capacity data (PSMC) value in volume per unit time representative of a max capacity of the liquid pumped from the tank of the pump station during the predetermined time period (T);
for the predetermined time period, determining at least one momentary Pump Station Capacity Utilization (PSCU_{M}) based on the determined values of the Inflow data (IN) and the Pump Station Max Capacity data (PSMC), using an overall formula PSCU_{M} (%)=100*IN/PSMC; and
determining a typical Pump Station Capacity Utilization (PSCU_{T}) for the pump station, representative of a capacity utilization of the pump station over time, based on the at least one momentary Pump Station Capacity Utilization (PSCU_{M}) value.

17. The method according to claim 16, wherein the step of determining the Inflow data (IN) comprises sub-steps of:
determining a rest-time (REST) required for a liquid level in the tank to rise from a pump stop liquid level (STOP) to a pump start liquid level (START) when all pumps of the at least one pump are inactive, wherein the rest-time (REST) is part of the predetermined time period (T);
determining the Inflow data (IN) representative of the inflow of liquid during the predetermined time period (T) by dividing a volume (V) by the determined rest-time (REST), using an expression V/REST, wherein the volume (V) is a liquid volume in the tank between the pump start liquid level (START) and the pump stop liquid level (STOP).

18. The method according to claim 16, wherein the Pump Station Max Capacity data (PSMC) is a maximum Outflow (Q_{M}) corresponding to all pumps of the at least one pump in the pump station being active concurrently and being operated at maximum operational speed.

19. The method according to claim 16, wherein the step of determining the Pump Station Max Capacity data (PSMC) comprises sub-steps of:
determining a run-time (RUN) required for a liquid level in the tank to lower from a pump start liquid level (START) to a pump stop liquid level (STOP) when all pumps of the at least one pump in the pump station are active concurrently and operated at maximum operational speed, wherein the run-time (RUN) is part of the predetermined time period (T); and
determining the Pump Station Max Capacity data (PSMC) representative of the max capacity of the pump station during the predetermined time period (T) by dividing a volume (V) by the determined run-time (RUN) and adding the Inflow data (IN) representative for the inflow of liquid during the predetermined time period (T), using a PSMC expression (V/RUN)+IN, wherein the volume (V) is a liquid volume in the tank between the pump start liquid level (START) and the pump stop liquid level (STOP).

20. The method according to claim 19, further comprising a step to determine a reduction factor (X), wherein the at least one pump comprises a plurality of pumps constituted by a first subset of pumps and a second subset of pumps, wherein the first subset of pumps and the second subset of pumps are not active concurrently during the predetermined time period (T), and wherein the step of determining the reduction factor (X) comprises sub-steps of:
determining a First Subset Max Capacity data (P1_MC) during a first pump cycle during the predetermined time period (T), wherein the First Subset Max Capacity data (P1_MC) is representative for a first subset max capacity of the first subset of pumps during the predetermined time period (T);
determining a Second Subset Max Capacity data (P2_MC) during a second pump cycle during the predetermined time period (T), wherein the Second Subset Max Capacity data (P2_MC) is representative for a second subset max capacity of the second subset of pumps during the predetermined time period (T); and
determining a reduction factor (X) by dividing the Pump Station Max Capacity data (PSMC) with the sum of the First Subset Max Capacity data (P1_MC) and the Second Subset Max Capacity data (P2_MC), using a reduction factor expression PSMC/(P1_MC+P2_MC).

21. The method according to claim 16, wherein the at least one pump comprises a plurality of pumps constituted by a first subset of pumps and a second subset of pumps, wherein the first subset of pumps and the second subset of pumps are not active concurrently during the predetermined time period (T), and wherein the step of determining the Pump Station Max Capacity data (PSMC) comprises sub-steps of:
determining a First Subset Max Capacity data (P1_MC) during a first pump cycle during the predetermined time period (T), wherein the First Subset Max Capacity data (P1_MC) is representative for a first subset max capacity of the first subset of pumps during the predetermined time period (T);
determining a Second Subset Max Capacity data (P2_MC) during a second pump cycle during the predetermined time period (T), wherein the Second Subset Max Capacity data (P2_MC) is representative for a second subset max capacity of the second subset of pumps during the predetermined time period (T); and
determining the Pump Station Max Capacity data (PSMC) representative of the max capacity of the pump station during the predetermined time period (T) by multiplying a reduction factor (X) with the sum of the First Subset Max Capacity data (P1_MC) and the Second Subset Max Capacity data (P2_MC), using a PSMC expression X*(P1_MC+P2_MC), wherein the reduction factor (X) is in the range 0.6-0.9.

22. The method according to claim 21, wherein the step of determining the First Subset Max Capacity data (P1_MC) comprises sub-steps of:
determining a first run-time (P1_RUN) required for a liquid level in the tank to lower from a pump start liquid level (START) to a pump stop liquid level (STOP) when pumps of the first subset of pumps are active concurrently and operated at maximum operational speed, wherein the first run-time (P1_RUN) is part of the predetermined time period (T); and
determining the First Subset Max Capacity data (P1_MC) by dividing a volume (V) by the determined first run-time (P1_RUN) and adding a first Inflow data (P1_IN) that is representative for the inflow of liquid during the first pump cycle, using a first subset max capacity expression (V/P1_RUN)+P1_IN, wherein the volume (V) is the liquid volume in the tank between the pump start liquid level (START) and the pump stop liquid level (STOP).

23. The method according to claim 22, wherein the first Inflow data (P1_IN) comprises the sub-steps of:
determining a first rest-time (P1_REST) required for the liquid level in the tank to rise from a pump stop liquid level (STOP) to a pump start liquid level (START) when all pumps of the at least one pump are inactive, wherein the first rest-time (P1_REST) is part of the predetermined time period (T); and
determining the first Inflow data (P1_IN) representative of the inflow of liquid during the predetermined time period (T) by dividing a volume (V) by the determined first rest-time (P1_REST), using a first Inflow expression V/P1_REST, wherein the volume (V) is the liquid volume in the tank between the pump start liquid level (START) and the pump stop liquid level (STOP).

24. The method according to claim 21, wherein the step of determining the Second Subset Max Capacity data (P2_MC) comprises sub-steps of:
determining a second run-time (P2_RUN) required for a liquid level in the tank to lower from a pump start liquid level (START) to a pump stop liquid level (STOP) when pumps of the second subset of pumps are active concurrently and operated at maximum operational speed, wherein the second run-time (P2_RUN) is part of the predetermined time period (T); and
determining the Second Subset Max Capacity data (P2_MC) by dividing a volume (V) by the determined second run-time (P2_RUN) and adding a second Inflow data (P2_IN) that is representative for the inflow of liquid during the second pump cycle, using a second subset max capacity expression (V/P2_RUN)+P2_IN, wherein the volume (V) is the liquid volume in that tank between the pump start liquid level (START) and the pump stop liquid level (STOP).

25. The method according to claim 24, wherein the second Inflow data (P2_IN) comprises the sub-steps of:
determining a second rest-time (P2_REST) required for the liquid level in the tank to rise from a pump stop liquid level (STOP) to a pump start liquid level (START) when all pumps of the at least one pump are inactive, wherein the second rest-time (P2_REST) is part of the predetermined time period (T); and
determining the second Inflow data (P2_IN) representative of the inflow of liquid during the predetermined time period (T) by dividing a volume (V) by the determined second rest-time (P2_REST), using a second Inflow expression V/P2_REST, wherein the volume (V) is the liquid volume in the tank between the pump start liquid level (START) and the pump stop liquid level (STOP).

26. The method according to claim 22, wherein the pumps of the first subset of pumps (P1) are active concurrently and operated at a reduced operational speed that is less than the maximum operational speed, and wherein the reduced operational speed corresponds to a reduced first Outflow (P1_Q_{R}) and an actual first run-time (P1_RUN_{A}) required for the liquid level in the tank to lower from a pump start liquid level (START) to a pump stop liquid level (STOP), wherein the determination of the first run-time (P1_RUN) comprises multiplying the actual first run-time (P1_RUN_{A}) with a ratio between the reduced first Outflow (P1_Q_{R}) and a maximum first Outflow (P1_Q_{M}), wherein the ratio between the reduced first Outflow (P1_Q_{R}) and the maximum first Outflow (P1_Q_{M}) is determined based on a predetermined relationship between operational speed and first Outflow (P1_Q), and the reduced operational speed.

27. The method according to claim 24, wherein the pumps of the second subset of pumps (P2) are active concurrently and operated at a reduced operational speed that is less than the maximum operational speed, and wherein the reduced operational speed corresponds to a reduced second Outflow (P2_Q_{R}) and an actual second run-time (P2_RUN_{A}) required for the liquid level in the tank to lower from a pump start liquid level (START) to a pump stop liquid level (STOP), wherein the determination of the second run-time (P2_RUN) comprises multiplying the actual second run-time (P2_RUN_{A}) with a ratio between the reduced second Outflow (P2_Q_{R}) and a maximum second Outflow (P2_Q_{M}), wherein the ratio between the reduced second Outflow (P2_Q_{R}) and the maximum second Outflow (P2_Q_{M}) is determined based on a predetermined relationship between operational speed and second Outflow (P2_Q_{R}), and the reduced operational speed.

28. The method according to claim 21, wherein the typical Pump Station Capacity Utilization (PSCU_{T}) is compared with a predetermined threshold A and a predetermined threshold B, wherein the predetermined threshold A is in the range of 85-100% and the predetermined threshold B is equal to a ratio between the lowest of the First Subset Max Capacity data (P1_MC) and the Second Subset Max Capacity data (P2_MC) divided by the Pump Station Max Capacity data (PSMC), using an expression 100*min(P1_MC;P2_MC)/PSMC, in order to estimate a capacity status of the pump station.

29. The method according to claim 16, wherein the typical Pump Station Capacity Utilization (PSCU_{T}) is determined based on weekly peak values for a last 1 to 10 weeks, or weekly average values for the last 1 to 10 weeks, or a 1 to 10 highest historic values.

30. A computer-readable storage medium having computer-readable program code portions embedded therein, wherein the computer-readable program code portions when executed by a computer cause the computer to carry out the steps of the method according to claim 16 in order to determine the typical Pump Station Capacity Utilization (PSCU_{T}).

31. The method according to claim 28, further comprising triggering an automatic alarm for alerting the operator if the typical Pump Station Capacity Utilization (PSCU_{T}) is below threshold A but above threshold B, indicating a risk that the pump station will become flooded if a peak inflow occurs or if one pump malfunctions.

32. The method according to claim 28, further comprising triggering an automatic alarm for alerting the operator if the typical Pump Station Capacity Utilization (PSCU_{T}) is above threshold A, indicating an imminent risk that even with all of the plurality of pumps operating, the plurality of pumps are not capable of pumping a typical inflow.

33. The method of claim 31, wherein the pump station further comprises a control unit connected to the plurality of pumps and to at least one sensor operatively mounted on the pump station, the at least one sensor selected from the group consisting of: one or more liquid level sensors configured to measure a liquid level in the tank, a flowmeter configured to measure the inflow, and a flowmeter configured to measure outflow, the control unit comprising or connected to a computer and a computer-readable storage medium having computer-readable program code portions embedded therein, the computer-readable program code portions when executed by the computer configured to cause the computer to perform the method steps of claim 31.

34. The method of claim 32, wherein the pump station further comprises a control unit connected to the plurality of pumps and to at least one sensor operatively mounted on the pump station, the at least one sensor selected from the group consisting of: one or more liquid level sensors configured to measure a liquid level in the tank, a flowmeter configured to measure the inflow, and a flowmeter configured to measure outflow, the control unit comprising or connected to a computer connected to a computer-readable storage medium having computer-readable program code portions embedded therein, the computer-readable program code portions when executed by the computer configured to cause the computer to perform the method steps of claim 17.
